(19) United States
(12) Patent Application Publication
(10) Pub. No.: US 2023/0282861 A1
(43) Pub. Date: Sep. 7, 2023

(54) REDOX FLOW BATTERY SYSTEMS AND METHODS OF MAKING AND USING

(71) Applicant: Cougar Creek Technologies, LLC, Kirkland, WA (US)

(72) Inventors: Liyu Li, Bellevue, WA (US); Qingtao Luo, Mukilteo, WA (US)

(21) Appl. No.: 18/116,770

(22) Filed: Mar. 2, 2023

Related U.S. Application Data
(60) Provisional application No. 63/416,294, filed on Oct. 14, 2022.
(60) Provisional application No. 63/317,267, filed on Mar. 7, 2022.

(51) Int. Cl. H01M 8/18; H01M 8/0221; H01M 8/0226; H01M 8/0213; H01M 4/96; H01M 4/88

(52) U.S. Cl. CPC H01M 8/188; H01M 8/0221; H01M 8/0226; H01M 8/0213; H01M 4/96; H01M 4/8803; H01M 4/8896

(57) ABSTRACT

A redox flow battery system includes an anolyte; a catholyte; a first electrode structure including a first electrode, a second electrode, and a base disposed between the first and second electrodes, the base including a thermoplastic material and conductive elements disposed in the thermoplastic material, wherein at least one of the first electrode or the second electrode is thermally bonded to the base by heating the base to soften the thermoplastic material and pressing the at least one of the first electrode or the second electrode into the thermoplastic material of the base; a first half-cell in which the first electrode is in contact with the anolyte; and a second half-cell in which the second electrode is in contact with the catholyte.

### RELATED PATENT APPLICATIONS

The present patent application claims the benefit of U.S. Provisional Patent Application Ser. No. 63/317,267, filed Mar. 7, 2022, and U.S. Provisional Patent Application Ser. No. 63/416,294, filed Oct. 14, 2022, all of which are incorporated herein by reference in their entireties.

### FIELD

The present invention is directed to the area of redox flow battery systems and methods of making and using redox flow battery systems. The present invention is also directed to redox flow battery systems and methods that include an electrode structure utilizing a base or sheet having thermoplastic material.

### BACKGROUND

The cost of renewable power generation has reduced rapidly in the past decade and continues to decrease as more renewable power generation elements, such as solar panels, are deployed. However, renewable power sources, such as solar, hydroelectric, and wind sources, are often intermittent and the pattern of user load does not typically coincide with the intermittent nature of the sources. There is a need for an affordable and reliable energy storage system to store power generated by renewable power sources when available and to provide power to users when there is insufficient power generation from the renewable power sources.

### BRIEF SUMMARY

One embodiment is a redox flow battery system that includes an anolyte; a catholyte; a first electrode structure including a first electrode, a second electrode, and a base disposed between the first and second electrodes, the base including a thermoplastic material and conductive elements disposed in the thermoplastic material, wherein at least one of the first electrode or the second electrode is thermally bonded to the base by heating the base to soften the thermoplastic material and pressing the at least one of the first electrode or the second electrode into the thermoplastic material of the base; a first half-cell in which the first electrode is in contact with the anolyte; and a second half-cell in which the second electrode is in contact with the catholyte.

In at least some embodiments, the thermoplastic material includes at least one of polyethylene, polypropylene, polyvinylidene fluoride, polyvinyl chloride, or chlorinated polyvinyl chloride. In at least some embodiments, the conductive elements include graphite or carbon particulates, particles, or fibers. In at least some embodiments, the first and second electrodes include graphite or carbon-based felt.

In at least some embodiments, the at least one of the first electrode or the second electrode is thermally bonded to the base by heating the base to a temperature above a glass transition temperature of the thermoplastic material. In at least some embodiments, the at least one of the first electrode or the second electrode is thermally bonded to the base by heating the base to a temperature of no more than 300, 250, 200, 150, 100, or 80° C. In at least some embodiments, the at least one of the first electrode or the second electrode is thermally bonded to the base by heating the base and applying a pressure of no more than 1, 0.5, 0.1, 0.05, or 0.01 MPa.

In at least some embodiments, the at least one of the first electrode or the second electrode is thermally bonded to the base by heating the base, applying a pressure, and maintaining the pressure as the base cools below a glass transition temperature of the thermoplastic material. In at least some embodiments, the at least one of the first electrode or the second electrode is thermally bonded to the base by heating the base to a temperature above 70° C. and applying a pressure and maintaining the pressure as the base cools below a temperature in a range of 20 to 60° C.

In at least some embodiments, the base includes 10 to 70 wt. % of the thermoplastic material. In at least some embodiments, the base has a thickness in a range of 0.1 to 5 mm.

Another embodiment is a method of making an electrode structure. The method includes forming a slurry including a) particulates, particles, or fibers made of graphite or carbon, b) particles of a thermoplastic material, and c) an inert liquid; forming the slurry into a sheet; pressing at least one electrode against the sheet; and extracting the inert liquid to leave a base attached to the at least one electrode, the base including the thermoplastic material and the particulates, particles, or fibers made of graphite or carbon disposed in the thermoplastic material.

In at least some embodiments, the at least one electrode is two electrodes and the pressing includes pressing the two electrodes against opposite sides of the sheet. In at least some embodiments, the slurry includes 0.1 to 50 wt. % of the inert liquid. In at least some embodiments, the thermoplastic material includes at least one of polyethylene, polypropylene, polyvinylidene fluoride, polyvinyl chloride, or chlorinated polyvinyl chloride.

A further embodiment is a method of making an electrode structure. The method includes providing a base including a thermoplastic material and conductive elements disposed in the thermoplastic material; heating the base to soften the thermoplastic material; and pressing at least one electrode into the thermoplastic material of the base.

In at least some embodiments, the at least one electrode includes a first electrode and a second electrode, wherein the pressing includes pressing the first and second electrodes into the thermoplastic material on opposite sides of the base. In at least some embodiments, the heating includes heating the base to a temperature above 70° C. and the pressing includes applying a pressure to the at least one electrode and maintaining the pressure as the base cools below a temperature in a range of 20 to 60° C. In at least some embodiments, the pressing includes applying a pressure of no more than 1, 0.5, 0.1, 0.05, or 0.01 MPa to the at least one electrode. In at least some embodiments, the heating includes heating the base to a temperature of no more than 300, 250, 200, 150, 100, or 80° C.

Yet another embodiment is a method for heating the anolyte and catholyte in a redox flow battery system. The method includes providing the redox flow battery system including the anolyte, the catholyte, a first half-cell, a first electrode disposed in the first half-cell and in contact with the anolyte, a second half-cell, and a second electrode disposed in the second half-cell and in contact with the catholyte; at least partially charging the redox flow battery system; and mixing a portion of the anolyte and a portion of the catholyte to produce heat as a self-discharging process.

In at least some embodiments, the method further includes charging or discharging the redox flow battery system. In at least some embodiments, the mixing occurs during the charging or discharging.

In at least some embodiments, the redox flow battery system includes a mixing chamber and the mixing includes directing the portion of the anolyte and the portion of the catholyte into the mixing chamber. In at least some embodiments, the redox flow battery system further includes an anolyte mixing pump in fluid communication with the first half-cell and the mixing chamber and a catholyte mixing pump in fluid communication with the second half-cell and the mixing chamber, wherein the directing includes operating the anolyte mixing pump to direct the portion of the anolyte into the mixing chamber and operating the catholyte mixing pump to direct the portion of the catholyte into the mixing chamber. In at least some embodiments, the method further includes directing a first portion of the mixed anolyte and catholyte toward the first half-cell and directing a second portion of the mixed anolyte and catholyte toward the second half-cell.

In at least some embodiments, the redox flow battery system includes a separator between the first half-cell and the second half-cell, wherein the separator is a porous membrane, wherein the mixing includes altering a pressure of the anolyte or the catholyte to cause the anolyte or the catholyte to pass through the porous membrane to mix with the catholyte or the anolyte, respectively. In at least some embodiments, the redox flow battery system further includes an anolyte tank, an anolyte pump in fluid communication with the first half-cell and the anolyte tank and configured to move anolyte between the anolyte tank and the first half-cell, a catholyte tank, and a catholyte pump in fluid communication with the second half-cell and the catholyte tank and configured to move catholyte between the catholyte tank and the second half-cell, wherein the altering includes altering operation of at least one of the anolyte pump or the catholyte pump to alter the pressure of the anolyte or the catholyte. In at least some embodiments, the method further includes altering a pressure of the anolyte or the catholyte to cause the anolyte or the catholyte to pass through the porous membrane to adjust relative levels of the anolyte and catholyte. In at least some embodiments, the altering includes measuring a level of the anolyte or catholyte using a level sensor.

Another embodiments is a redox flow battery system that includes an anolyte; a catholyte; a first half-cell including a first electrode in contact with the anolyte; a second half-cell including a second electrode in contact with the catholyte; and a mixing chamber in fluid communication with the first half-cell and the second half-cell and configured for selectively mixing a portion of the anolyte with a portion of the catholyte.

In at least some embodiments, the redox flow battery system further includes an anolyte mixing pump in fluid communication with the first half-cell and the mixing chamber and configured to selectively direct anolyte to the mixing chamber and a catholyte mixing pump in fluid communication with the second half-cell and the mixing chamber and configured to selectively direct catholyte to the mixing chamber. In at least some embodiments, the redox flow battery system further includes an anolyte tank, an anolyte pump in fluid communication with the first half-cell and the anolyte tank and configured to move anolyte between the anolyte tank and the first half-cell, a catholyte tank, and a catholyte pump in fluid communication with the second half-cell and the catholyte tank and configured to move catholyte between the catholyte tank and the second half-cell.

In at least some embodiments, the redox flow battery system further includes at least one level sensor disposed in at least one of the anolyte tank, the catholyte tank, the first-half-cell, or the second half-cell.

A further embodiments is a method for reducing or avoiding overheating when circulation of anolyte and catholyte in a redox flow battery system stops. The method includes providing the redox flow battery system including the anolyte, the catholyte, a first half-cell, a first electrode disposed in the first half-cell and in contact with the anolyte, an anolyte tank in fluid communication with the first half-cell and configured for storing at least a portion of the anolyte, an anolyte pump in fluid communication with the first half-cell and the anolyte tank and configured for pumping anolyte between the first half-cell and the anolyte tank, a second half-cell, a second electrode disposed in the second half-cell and in contact with the catholyte, a catholyte tank in fluid communication with the second half-cell and configured for storing at least a portion of the catholyte, a catholyte pump in fluid communication with the second half-cell and the catholyte tank and configured for pumping catholyte between the second half-cell and the catholyte tank, and a porous membrane between the first and second half-cells; and stopping circulation of the anolyte and catholyte by, first, stopping only one of the anolyte pump or the catholyte pump while maintaining pumping by another one of the anolyte or the catholyte pump for at least one minute.

In at least some embodiments, the stopping includes reducing pumping by the other one of the anolyte or the catholyte pump to no more than 75% of full operation. In at least some embodiments, the stopping includes reducing pumping by the other one of the anolyte or the catholyte pump to no more than 50% of full operation. In at least some embodiments, the stopping includes maintaining pumping by the other one of the anolyte or the catholyte pump for at least two minutes. In at least some embodiments, the stopping includes maintaining pumping by the other one of the anolyte or the catholyte pump for at least five minutes. In at least some embodiments, the stopping includes maintaining pumping by the other one of the anolyte or the catholyte pump for at least ten minutes.

Yet another embodiment is a method of adjusting a level difference between anolyte and catholyte in a redox flow battery system. The method includes providing the redox flow battery system including the anolyte, the catholyte, a first half-cell, a first electrode disposed in the first half-cell and in contact with the anolyte, an anolyte tank in fluid communication with the first half-cell and configured for storing at least a portion of the anolyte, an anolyte pump in fluid communication with the first half-cell and the anolyte tank and configured for pumping anolyte between the first half-cell and the anolyte tank, a second half-cell, a second electrode disposed in the second half-cell and in contact with the catholyte, a catholyte tank in fluid communication with the second half-cell and configured for storing at least a portion of the catholyte, a catholyte pump in fluid communication with the second half-cell and the catholyte tank and configured for pumping catholyte between the second half-cell and the catholyte tank, and a porous membrane between the first and second half-cells; and adjusting a level difference between the anolyte and the catholyte by adjusting pumping pressures of the anolyte pump, catholyte pump, or both to cause either the anolyte or the catholyte to flow through the porous membrane and mix with the catholyte or anolyte, respectively.

In at least some embodiments, the adjusting includes measuring a level of the anolyte or the catholyte using at least one level sensor. In at least some embodiments, the at least one level sensor is disposed in at least one of the anolyte tank, the catholyte tank, the first half-cell, or the second half-cell.

Another embodiment is a redox flow battery system that includes an anolyte; a catholyte; a first half-cell including a first electrode in contact with the anolyte; a second half-cell including a second electrode in contact with the catholyte; a plurality of anolyte tanks in fluid communication with the first half-cell and configured for storing a portion of the anolyte, each of the anolyte tanks including a gas chamber at a top of the anolyte tank where anolyte is not present; a plurality of catholyte tanks in fluid communication with the second half-cell and configured for storing a portion of the catholyte, each of the catholyte tanks including a gas chamber at a top of the catholyte tank where catholyte is not present; a piping arrangement coupling the gas chambers of all of the anolyte and catholyte tanks together; and a bent tube extending from the gas chamber of a one of the anolyte or catholyte tanks and having liquid disposed in the bent tube to facilitate leak detection.

A further embodiment is a redox flow battery system that includes an anolyte; a catholyte; a first half-cell including a first electrode in contact with the anolyte; a second half-cell including a second electrode in contact with the catholyte; an anolyte tank in fluid communication with the first half-cell and configured for storing a portion of the anolyte; a catholyte tank in fluid communication with the second half-cell and configured for storing a portion of the catholyte; an anolyte pump configured to pump anolyte between the anolyte tank and the first half-cell; a catholyte pump configured to pump catholyte between the catholyte tank and the second half-cell, wherein at least one of the anolyte pump or the catholyte pump is a variable flow rate pump; a first level sensor and a second level sensor, wherein the first level sensor is configured to measure a liquid level in the anolyte tank and the second level sensor is configured to measure the liquid level in the catholyte tank; and a controller coupled to the anolyte pump, the catholyte pump, the first level sensor, and the second level sensor, wherein the controller is configured to maintain a predefined liquid level difference between the anolyte tank and the catholyte tank by determining a current liquid level difference using the first level sensor and the second level sensor and adjusting the current liquid level difference by altering a flow rate of the variable flow rate pump.

Yet another embodiment is a method for removing Fe(OH)₃ precipitate generated in a Fe—Cr redox flow battery system. The method includes providing the Fe—Cr redox flow battery system including an anolyte containing iron ions, a catholyte containing chromium ions, a first half cell including a first electrode in contact with the anolyte, a second half-cell including a second electrode in contact with the catholyte, a porous separator disposed between the first half-cell and the second-half cell, an anolyte tank in fluid communication with the first half-cell and configured for storing a portion of the anolyte, a catholyte tank in fluid communication with the second half-cell and configured for storing a portion of the catholyte, an anolyte pump configured to pump anolyte between the anolyte tank and the first half-cell, and a catholyte pump configured to pump catholyte between the catholyte tank and the second half-cell; and altering a flow rate of at least one of the anolyte pump or the catholyte pump to cause catholyte to flow through the porous separator into the first half-cell and dissolve the Fe(OH)₃ precipitate.

Another embodiment is a method for removing a deposited metal hydrogenation catalyst generated in a Fe—Cr redox flow battery system. The method includes providing the Fe—Cr redox flow battery system including an anolyte containing iron ions, a catholyte containing chromium ions, a first half cell including a first electrode in contact with the anolyte, a second half-cell including a second electrode in contact with the catholyte, a porous separator disposed between the first half-cell and the second-half cell, an anolyte tank in fluid communication with the first half-cell and configured for storing a portion of the anolyte, a catholyte tank in fluid communication with the second half-cell and configured for storing a portion of the catholyte, an anolyte pump configured to pump anolyte between the anolyte tank and the first half-cell, and a catholyte pump configured to pump catholyte between the catholyte tank and the second half-cell; and altering a flow rate of at least one of the anolyte pump or the catholyte pump to cause anolyte to flow through the porous separator into the second half-cell to reduce the deposited metal hydrogenation catalyst.

Yet another embodiment is a system that includes a redox flow battery system including an anolyte, a catholyte, a first half-cell including a first electrode in contact with the anolyte, a second half-cell including a second electrode in contact with the catholyte, and a first separator separating the first half-cell from the second half-cell. The system also includes a balance arrangement including a balance electrolyte including Fe²⁺ ions and H⁺ ions in solution, a third half-cell including a third electrode in contact with the anolyte, and a fourth half-cell including a fourth electrode in contact with the balance electrolyte.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic diagram of one embodiment of a redox flow battery system, according to the invention;

FIG. 2A is a schematic diagram of one embodiment of a system that includes a redox flow battery system in conjunction with a balancing arrangement, according to the invention;

FIG. 2B is a schematic diagram of one embodiment of the balancing arrangement of the system of FIG. 2A, according to the invention;

FIG. 2C is a schematic diagram of another embodiment of a system that includes a redox flow battery system in conjunction with a balancing arrangement, according to the invention;

FIG. 2D is a schematic diagram of one embodiment of the balancing arrangement of the system of FIG. 2C, according to the invention;

FIG. 2E is a schematic diagram of another embodiment of a balancing arrangement, according to the invention;

FIG. 2F is a schematic diagram of a further embodiment of a system that includes a redox flow battery system in conjunction with a balancing arrangement, according to the invention;

FIG. 2G is a schematic diagram of one embodiment of the balancing arrangement of the system of FIG. 2F, according to the invention;

FIG. 3A is a schematic diagram of electrolyte tanks of a redox flow battery system with pressure release valves, according to the invention;

FIG. 3B is a schematic diagram of an electrolyte tank of a redox flow battery system with a liquid-containing U-tube arrangement for pressure relief, according to the invention;

FIG. 3C is a schematic diagram of electrolyte tanks of a redox flow battery system with an arrangement for migration of gas between the tanks, according to the invention;

FIG. 3D is a schematic diagram of one embodiment of a leak sensor arrangement for a redox flow battery system, according to the invention;

FIG. 4 is a schematic diagram of another embodiment of a redox flow battery system with a temperature zone, according to the invention;

FIG. 5A is a schematic cross-sectional view of one embodiment of an electrode structure, according to the invention;

FIG. 5B is a schematic cross-sectional view of the electrode structure of FIG. 5A in a redox flow battery arrangement, according to the invention;

FIG. 6 is a schematic diagram of one embodiment of a redox flow battery system with an arrangement to combine portions of the anolyte and catholyte to heat the anolyte and catholyte, according to the invention;

FIG. 7 is a schematic diagram of one embodiment of a redox flow battery system with one or more level sensors, according to the invention;

FIG. 8 is a schematic diagram of one embodiment of a redox flow battery string in which redox flow battery systems are connected in series, according to the invention;

FIG. 9A is a schematic side view of one embodiment of a multi-layer electrolyte tank, according to the invention; and

FIG. 9B is a schematic cross-sectional view of the wall of the multi-layer electrolyte tank of FIG. 9A, according to the invention.

### DETAILED DESCRIPTION

The present invention is directed to the area of redox flow battery systems and methods of making and using redox flow battery systems. The present invention is also directed to redox flow battery systems and methods that utilize temporal energy profile for operation of the redox flow battery system.

Redox flow battery systems are a promising technology for the storage of energy generated by renewable energy sources, such as solar, wind, and hydroelectric sources, as well as non-renewable and other energy sources. As described herein, in at least some embodiments, a redox flow battery system can have one or more of the following properties: long life; reusable energy storage; or tunable power and storage capacity.

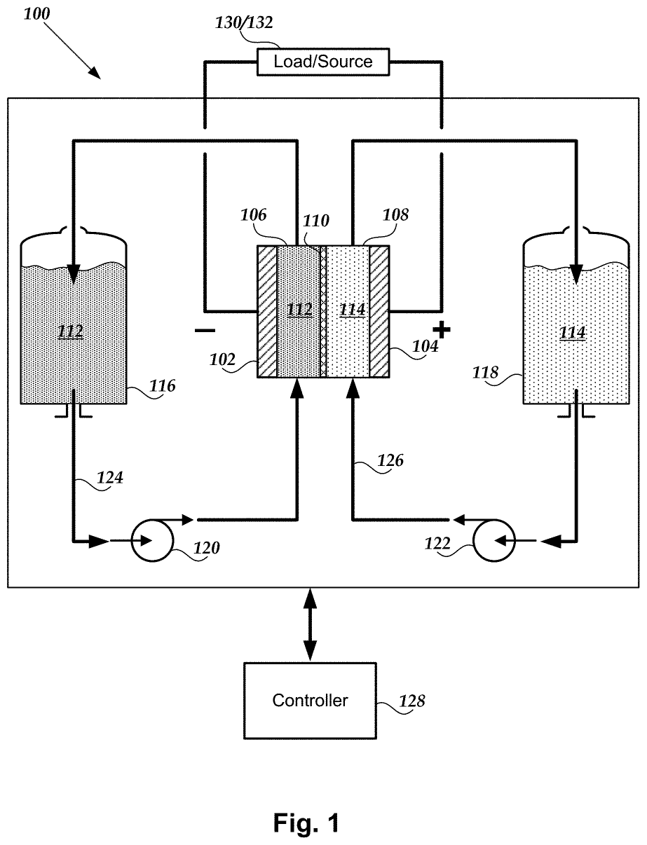

FIG. 1 illustrates one embodiment of a redox flow battery system 100. It will be recognized that other redox flow battery systems 100 may include more or fewer elements and the elements may be arranged differently than shown in the illustrated embodiments. It will also be recognized that the description below of components, methods, systems, and the like can be adapted to other redox flow battery systems different from the illustrated embodiments.

The redox flow battery system 100 of FIG. 1 includes two electrodes 102, 104 and associated half-cells 106, 108 that are separated by a separator 110. The electrodes 102, 104 can be in contact or separated from the separator. Electrolyte solutions flow through the half-cells 106, 108 and are referred to as the anolyte 112 and the catholyte 114. The redox flow battery system 100 further includes an anolyte tank 116, a catholyte tank 118, an anolyte pump 120, a catholyte pump 122, an anolyte distribution arrangement 124, and a catholyte distribution arrangement 126. The anolyte 112 is stored in the anolyte tank 116 and flows around the anolyte distribution arrangement 124 through, at least in part, action of the anolyte pump 120 to the half-cell 106. The catholyte 114 is stored in the catholyte tank 118 and flows around the catholyte distribution arrangement 126 through, at least in part, action of the catholyte pump 122 to the half-cell 108. It will be recognized that, although the illustrated embodiment of FIG. 1 includes a single one of each of the components, other embodiments can include more than one of any one or more of the illustrated components. For example, other embodiments can include multiple electrodes 102, multiple electrodes 104, multiple anolyte tanks 116, multiple catholyte tanks 118, multiple half-cells 112, or multiple half-cells 114, or any combination thereof.

Examples of redox flow battery systems and methods of using and making such systems are disclosed in U.S. Pat. Nos. 10,777,836; 10,826,102; 11,189,854; 11,201,345; and 11,233,263 and U.S. Patent Application Publications Nos. 2022/0158207; 2022/0158211; 2022/0158212; 2022/0158213; and 2022/0158214, all of which are incorporated herein by reference in their entireties. The redox flow battery systems and methods in these cited references can be modified to include any of the components, methods, techniques or the like described herein or used in the methods described herein. In addition, the redox flow battery systems and methods disclosed herein can be modified to include any of the components, methods, techniques or the like described in these cited references or used in the methods described in these cited references.

The anolyte and the catholyte are electrolytes and can be the same electrolyte or can be different electrolytes. During energy flow into or out of the redox flow battery system 100, the electrolyte in one of the half-cells 106, 108 is oxidized and loses electrons and the electrolyte in the other one of the half-cells is reduced and gains electrons.

The redox flow battery system 100 can be attached to a load/source 130/132, as illustrated in FIG. 1. In a charge mode, the redox flow battery system 100 can be charged or recharged by attaching the flow battery to a source 132. The source 132 can be any power source including, but not limited to, fossil fuel power sources, nuclear power sources, other batteries or cells, and renewable power sources, such as wind, solar, or hydroelectric power sources. In a discharge mode, the redox flow battery system 100 can provide energy to a load 130. In the charge mode, the redox flow battery system 100 converts electrical energy from the source 132 into chemical potential energy. In the discharge mode, the redox flow battery system 100 converts the chemical potential energy back into electrical energy that is provided to the load 130.

The redox flow battery system 100 can also be coupled to a controller 128 that can control operation of the redox flow battery system. For example, the controller 128 may connect or disconnect the redox flow battery system 100 from the load 130 or source 132. The controller 128 may control operation of the anolyte pump 120 and catholyte pump 122. The controller 128 may control operation of valves associated with the anolyte tank 116, catholyte tank 118, anolyte distribution system 124, catholyte distribution system 126, or half-cells 106, 108. The controller 128 may be used to control general operation of the redox flow battery system 100 include switching between charge mode, discharge mode, and, optionally, a maintenance mode (or any other suitable modes of system operation.) In at least some embodiments, the controller or the redox flow battery system may control the temperature of within the half-cells or elsewhere in the system. In at least some embodiments, the temperature of the half-cells (or the system in general or portions of the system) is controlled to be no more than 65, 60, 55, or 50 degrees Celsius during operation.

In at least some embodiments, the anolyte pump 120 or catholyte pump 122 (or both) can be operated to increase or maintain the temperature of the anolyte/catholyte or the half-cells. Operation of the pumps generates heat that can be transferred, at least in part, to the anolyte or catholyte. In at least some embodiments, if the temperature of the anolyte or catholyte (or the corresponding half-cell 106, 108) falls below a pre-determined value the anolyte pump 120 or catholyte pump 122, respectively, initiates or increases operation to generate heat that is transferred, at least in part, to the anolyte or catholyte, respectively.

Any suitable controller 128 can be used including, but not limited to, one or more computers, laptop computers, servers, any other computing devices, or the like or any combination thereof and may include components such as one or more processors, one or more memories, one or more input devices, one or more display devices, and the like. The controller 128 may be coupled to the redox flow battery system through any wired or wireless connection or any combination thereof. The controller 128 (or at least a portion of the controller) may be located local to the redox flow battery system 100 or located, partially or fully, non-locally with respect to the redox flow battery system.

The electrodes 102, 104 can be made of any suitable material including, but not limited to, graphite or other carbon materials (including solid, felt, paper, or cloth electrodes made of graphite or carbon), gold, titanium, lead, or the like. The two electrodes 102, 104 can be made of the same or different materials. In at least some embodiments, the redox flow battery system 100 does not include any homogenous or metallic catalysts for the redox reaction in the anolyte or catholyte or both. This may limit the type of material that may be used for the electrodes.

The separator 110 separates the two half-cells 106, 108. In at least some embodiments, the separator 110 allows the transport of selected ions (for example, H⁺, Cl⁻, or iron or chromium ions or any combination thereof) during the charging or discharging of the redox flow battery system 100. In some embodiments, the separator 110 is a microporous membrane. Any suitable separator 110 can be used and examples of suitable separator include, but are not limited to, ion transfer membranes, anionic transfer membranes, cationic transfer membranes, microporous separators, or the like or any combination thereof.

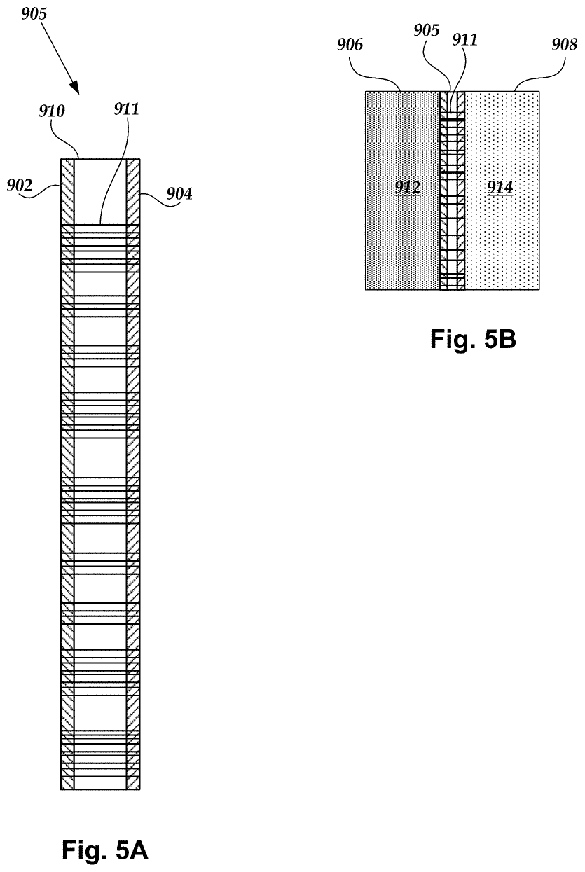

An alternative to the electrodes 102, 104 and separator 110 is an electrode structure (which can be referred to as a “bipolar electrode”) 905 that acts as an anode, a cathode, and a separator, as illustrated in FIG. 5A. The electrode structure 905 includes a base 910 with conductive elements 911 that extend through the base from a first surface of the base to a second surface of the base. These conductive elements 911 are exposed in the two half-cells 906, 908, as illustrated in FIG. 5B. The base 910 can act as the separator 110.

The base 910 is made of a material that is impermeable to, or substantially resists or hinders flow of, the anolyte and catholyte through the base. Examples of such materials include plastic (such as polypropylene, polyethylene, perfluoroalkoxy alkane (PFA), polyvinylidene fluoride (PVDF), polytetrafluoroacetic acid (PTFE), polyvinyl chloride (PVC), chlorinated polyvinyl chloride (CPVC), or the like), a resin, a carbon or graphite plate, a metal plate, a metal-alloy plate, or the like. In at least some embodiments, the base is non-conductive. In at least some embodiments, the base is conductive, such as a graphite plate. In at least some embodiments, the conductivity of the base 910 between the first surface and the second surface is less than the conductivity of the conductive elements 911.

The conductive elements 911 extend through the base 910 so that they are accessible to both the anolyte and catholyte. Examples of suitable conductive elements include, but are not limited to, metal wires (for example, titanium iron, copper, zinc, silver, gold, or platinum wires), carbon fibers, graphite fibers aligned for electron conduction through the base, silicon carbide, or the like or any combination thereof. The conductive elements 911 can also be made of multiple small connecting conductive particles, which form a conductive network. The conductive elements 911 form part of (or the entirety of) electrodes 902, 904 which are disposed on the opposing first and second surfaces of the base 910. Optionally, electrodes 902, 904 can include additional conductive material, such as metal, carbon fiber, carbon felt, silicon carbide, or the like, that does not extend through the base 910 but is disposed on the surface of the base or extend into, but not through, the base. In at least some embodiments, the electrodes 902 and 904 are thin porous conductive layers made of carbon fibers or carbon particles, with, or without, a plastic binder (e.g., a thermoplastic material as described below).

In at least some embodiments, the base 910 can be molded with the conductive elements 911 arranged so that the conductive elements will extend through the base. In at least some embodiments, the conductive elements 911 may be inserted or pushed through the base 910. In at least some embodiments, the base 910 can be heated after passing the conductive elements 911 through the base to flow the material of the base and embed medial portions of the conductive elements within the base.

In at least some embodiments, the electrodes 902, 904 are made of graphite or carbon-based particles or felt. In at least some embodiments, the electrodes 902, 904 have a thickness in a range of 0.01 to 10 mm. In at least some embodiments, the base 910 includes conductive elements 911 of particulates, particles, or fibers made of graphite or carbon disposed in a thermoplastic material. Examples of suitable thermoplastic materials include, but are not limited to, polyethylene, polypropylene, polyvinylidene fluoride, polyvinyl chloride, chlorinated polyvinyl chloride, or the like. In at least some embodiments, the percentage by weight of thermoplastic material in the base 910 is in the range of 10 to 70 wt. %, 20 to 50 wt. %, or 25 to 40 wt. %. In at least some embodiments, the thickness of the base 910 in in the range of 0.1 to 5 mm, 0.5 to 2 mm, 0.8 to 1.5 mm, or 0.9 to 1.2 mm.

In at least some embodiments, the electrodes 902, 904 and the base 910 form a three layer arrangement with the base 910 formed of thermoplastic material and forming a separator. The electrodes 902, 904 can include a thermoplastic material is a binder for the carbon-based particles or felt.

In at least some embodiments, one or both of the electrodes 902, 904 is bonded to the base 910 using a conductive adhesive. Any suitable conductive adhesive can be used.

In at least some embodiments, one or both of the electrodes 902, 904 is bonded to the base 910 by application of heat and pressure using, for example, a hot press or other apparatus. In at least some embodiments, the hot press (or other apparatus) is heated to a temperature sufficient to soften the thermoplastic material of the base 910.

In at least some embodiments, the temperature is at least 70 or 80° C. In at least some embodiments, the temperature is no more than 300, 250, 200, 150, 100, or 80° C. In at least some embodiments, the temperature is above the glass transition temperature of the thermoplastic material and, optionally, no more than 300, 250, 200, 150, 100, or 80° C.

In at least some embodiments, a pressure is applied to the hot press (or other apparatus) that is sufficient to push the electrode(s) 902, 904 into the base 910, but not break through the base (for example, a pressure no more than 1, 0.5, 0.1, 0.05, or 0.01 MPa.). In at least some embodiments, the pressure is applied for a time period in a range of 5 to 1000 seconds, 5 to 500 seconds, 10 to 300 seconds, or 50 to 200 seconds.

In at least some embodiments, the hot press (or other apparatus) is allowed to cool to a temperature below the glass transition temperature of the thermoplastic material or to a temperature in a range of 20 to 60° C. before removing the base 910 and electrode(s) 902, 904 from the hot press (or other apparatus.)

In at least some embodiments, a length of the flow field of the bipolar electrode 905 is at least 7.5, 15, 30, 40, or 50 cm.

As another method of making the bipolar electrode, the particulates, particles, or fibers made of graphite or carbon and particles of the thermoplastic material are dissolved or suspended in an inert liquid, such as mineral oil or other inert oil or any other suitable hydrocarbon- or water-based liquid, to form a slurry. In at least some embodiments, the amount of inert liquid in the slurry is in a range of 0.1 to 50 wt. %, 0.5 to 10 wt. %, or 1 to 5 wt. %. The slurry is presented in the form of a sheet (similar to base 910 except in slurry form). In at least some embodiments, the sheet of slurry has a thickness that is in the range of 0.1 to 2 mm, although other thicknesses can be used. One electrode or both electrodes can be pressed against the sheet with or without heating. If heated, the electrode and sheet can be cooled with or without use of a cooling device. The inert liquid is removed by, for example, extraction, evaporation, or any other suitable method. As an example, mineral oil can be removed by extraction using toluene, hexane, gasoline, diesel, kerosene, or the like. Alternative or additionally, extraction can be facilitated by direct heating.

Although the electrode structure 905 is disclosed herein in the context of a Fe—Cr redox flow battery system, it will be recognized that the electrode structure 905 can be used in other redox flow battery systems including, but not limited to, vanadium redox flow battery systems, vanadium-bromine redox flow battery systems, vanadium-iron redox flow battery systems, zinc-bromine redox flow battery systems, all iron redox flow battery systems, organic aqueous redox flow battery systems, or the like. The electrode structure 905 can also be used in other electrochemical systems and methods.

Redox flow battery systems can be safe, reliable, and provide a reusable energy storage medium. It has been challenging, however, to identify a redox flow battery system that has a desirable storage energy with a long life (e.g., a flow battery system that maintains its storage capacity for many charge/discharge cycles) and is made of materials that have abundant availability (e.g., materials that are abundant on Earth and are commercially mined and available in relatively large quantities). Current lithium and vanadium batteries utilize materials that have limited availability. The storage capacity of many conventional battery systems also degrades when subjected 10, 50, or 100 charge/discharge cycles or more. A further challenge for aqueous redox flow battery systems is to manage or avoid the evolution of hydrogen or oxygen from water.

As described herein, a suitable and useful redox flow battery system is an iron-chromium Fe—Cr) redox flow battery system utilizing Fe³⁺/Fe²⁺ and Cr³⁺/Cr²⁺ redox chemistry. Iron and chromium are generally readily commercially available and, at least in some embodiments, the storage capacity of a Fe—Cr redox flow battery system does not degrade by more than 10% or 20% over at least 100, 200, 250, or 500 charge/discharge cycles or can be configured, using maintenance procedures, to maintain at least 70%, 80%, or 90% storage capacity over at least 100, 200, 250, or 500 charge/discharge cycles.

In at least some embodiments, the electrolytes (i.e., the catholyte or anolyte) of a Fe—Cr redox flow battery system include an iron-containing compound or a chromium-containing compound (or both) dissolved in a solvent. In some embodiments, the anolyte and catholyte contain both the iron-containing compound and the chromium-containing compound. The concentrations of these two compounds in the anolyte and catholyte can be the same or different. In other embodiments, the catholyte includes only the iron-containing compound and the anolyte includes only the chromium-containing compound.

In at least some embodiments, the chromium-containing compound can be, for example, chromium chloride, chromium sulfate, chromium bromide, or the like or any combination thereof. In at least some instances, it has been found that chloride-complexed chromium ions (for example, Cr(H₂O)₅Cl^{2+/+}) have faster reaction kinetics and lower H₂ production than at least some other chromium ion complexes (for example, Cr(H₂O)₆^{3+/ 2+}). Accordingly, the inclusion of chloride in the anolyte (for example, from the chromium-containing compound, the solvent, or both) can be beneficial.

It has been found that chromium can form complexes with nitrogen-containing ligands that, at least in some instances, are more stable than chloride complexes of chromium. In at least some instances, the chromium complexes with nitrogen-containing ligands may be more redox active or may result in fewer side reactions (such as hydrogen generation) in the Fe—Cr redox flow battery. In at least some embodiments, the chromium-containing compound can be a chromium complex including at least one of the following nitrogen-containing ligands: ammonia (NH₃), ammonium (NH₄⁺), urea (CO(NH₂)₂), thiocyanate (SCN⁻), or thiourea (CS(NH₂)₂) or any combination thereof Examples of complexes with combinations of different nitrogen-containing ligands include chromium complexes with ammonia and urea.

In at least some embodiments, the chromium complex has the formula [Cr³⁺(J)ₓ(M)_{y}(H₂O)_{z}] where x is a positive integer and y and z are non-negative integers with x+y+z=6, J is selected from the group consisting of NH₃, NH₄⁺, CO(NH₂)₂, SCN⁻, or CS(NH₂)₂, and each M is different from J and independently selected from the group consisting of Cl⁻, F⁻, Br⁻, I⁻, NH₄⁺, NH₃, ethylenediaminetetraacetic acid (EDTA), CN⁻, SCN⁻, S²⁻, O—NO₂⁻, OH₂⁻, NO₂⁻, CH₅H₅N, NC₅H₄—C₅H₄N, C₁₂H₈N₂, CO(NH₂)₂, CS(NH₂)₂, P(C₆H₅)₃, —CO, CH₃—CO—CH₂—CO—CH₃, NH₂—CH₂—NH₂, NH₂CH₂COO⁻, O—SO₂²⁻, or P(o-tolyl)₃. This chromium-containing compound can also include any suitable counterions including, but not limited to, ammonium, chloride, bromide, iodide, fluoride, sulfate, nitrate, or the like or any combination thereof. One example of a chromium complex is Cr(NH₃)ₓCl_{y}(H₂O)_{z} where x and z are in the range of 1 to 6 and y is in the range of 1 to 3. In at least some embodiments, the ratio of Cr to NH₃ (or other nitrogen-containing ligand) for the anolyte or catholyte can be less than 1 as long as a portion of the chromium ions are complexed with ammonia (or other nitrogen-containing ligand).

In at least some embodiments, the chromium complex can be created in-situ in the electrolyte (either the anolyte or catholyte or both) by exposing a chromium salt (for example, chromium chloride, chromium sulfate, chromium bromide, or the like or any combination thereof) or other chromium compound to a ligand-containing compound (for example, ammonia, ammonium chloride, urea, potassium thiocyanate, sodium thiocyanate, or thiourea.)

In at least some embodiments, the molar ratio of the nitrogen-containing ligand(s) to chromium in the electrolyte (either the anolyte or catholyte or both) is in the range of 1:10 to 10:1. In the case of a chromium complex with ammonia and urea, the molar ratio of ammonia to urea is in the range of 1:10 to 10:1. It will be understood that at least some of the nitrogen-containing ligand(s) may not be complexed with chromium. For example, at least some of the nitrogen-containing ligand(s) may be complexed with iron or may not be complexed within the electrolyte.

The iron-containing compound can be, for example, iron chloride; iron sulfate; iron bromide; an iron complex including at least one of ammonia (NH₃), ammonium (NH₄⁺), urea (CO(NH₂)₂), thiocyanate (SCN⁻), or thiourea (CS(NH₂)₂) as a ligand; or the like or any combination thereof. In at least some embodiments, the iron complex can include the same ligands as a chromium complex in the same electrolyte (either the anolyte or catholyte or both) or a subset of those ligands.

The solvent can be water; an aqueous acid, such as, hydrochloric acid, hydrobromic acid, sulfuric acid, or the like; or an aqueous solution including a soluble salt of a weak acid or base, such as ammonium chloride. In at least some embodiments, the water content of the anolyte or catholyte (or both) is at least 40, 45, or 50 wt. %. In at least some embodiments, both the catholyte and the anolyte of an Fe—Cr redox flow battery system includes iron chloride and chromium chloride dissolved in hydrochloric acid. In at least some embodiments, the catholyte of an Fe—Cr redox flow battery system includes iron chloride dissolved in hydrochloric acid and the anolyte includes chromium chloride dissolved in hydrochloric acid.

In at least some embodiments, a nitrogen-containing compound may also provide benefits relative to the solvent even if the nitrogen-containing compound is not a ligand of chromium or iron. For example, urea or thiourea in the electrolyte (either the anolyte or catholyte or both) can neutralize HCl in the electrolyte which may reduce HCl vapor during battery operation. As another example, a solvent with ammonium or ammonium ions (for example, replacing all or part of the hydrochloric acid with ammonium chloride) can result in an effective electrolyte (either the anolyte or catholyte or both) that has lower acidity.

In at least some embodiments, both the catholyte and the anolyte of an Fe—Cr redox flow battery system includes iron chloride and chromium chloride dissolved in hydrochloric acid. In at least some embodiments, the catholyte of an Fe—Cr redox flow battery system includes iron chloride dissolved in hydrochloric acid and the anolyte includes chromium chloride dissolved in hydrochloric acid.

In at least some embodiments, the molarity of iron in the catholyte or the anolyte or both is in a range of 0.5 to 2 or is at least 1 M. In at least some embodiments, the molarity of chromium in the anolyte or the catholyte or both is in a range of 0.1 to 2 or is at least 0.2, 0.5, or 1 M. In at least some embodiments, the molarity of the hydrochloric acid or other aqueous acid or base is in a range of 0.5 to 2. In at least some embodiments, the molarity of ammonia or ammonium ions is in a range of 0.5 to 4.

As one example of a method for forming an anolyte or catholyte with chromium complex, a 100 gram mixture of FeCl₂·4H₂O (35 wt. %), CrCl₃·6H₂O (45 wt. %), and NH₄Cl (20%) was added to a 250 mL beaker and dissolved in distilled ionized water to form a 150 mL solution. Stirring of the solution at 50° C. to 60° C. accelerated dissolving. 2 mL of 37 wt. % HCl was added to the solution to adjust the pH.

In another example, a 100 gram mixture of FeCl₂·4H₂O (32 wt. %), CrCl₃·6H₂O (43 wt. %), and CO(NH₂)₂ (25%) was added to a 250 mL beaker and dissolved in distilled ionized water to form a 150 mL solution. 1.5 mL of 37 wt. % HCl was added to the solution to adjust the pH.

As a third example, a 100 gram mixture of FeCl₂ 4H₂O (35 wt. %), CrCl₃·6H₂O (45 wt. %), NH₄Cl (10%), and CO(NH₂)₂ (10%) was added to a 250 mL beaker and dissolved in distilled ionized water to form a 150 mL solution. 2 mL of 37 wt. % HCl was added to the solution to adjust the pH.

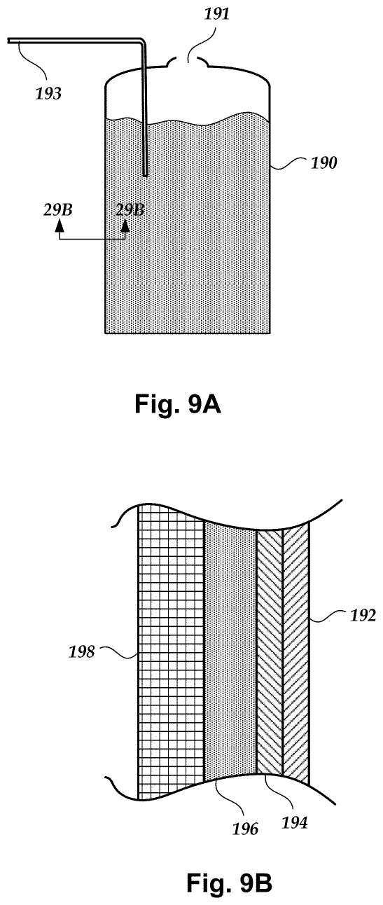

The anolyte and catholyte tanks 116, 118 are referred to as electrolyte tanks. Any suitable tank can be used for the anolyte and catholyte tanks 116, 118 including commercial electrolyte tanks and other known designs of electrolyte tanks. In at least some embodiments, at last one of the electrolyte tanks is a multi-layer electrolyte tank that includes at least one plastic layer, at least one thermal insulation layer, and at least one mechanical support layer. FIGS. 9A and 9B illustrates one embodiment of a multi-layer tank 190 that includes a first plastic layer 192 that contacts the electrolyte solution, at least one second plastic layer 194 disposed over the first plastic layer, at least one thermal insulation layer 196, and at least one mechanical support layer 198. In at least some embodiments, the tank 190 has an internal volume of at least 5, 10, or 25 m³.

The first and second plastic layers 192, 194 can be made of any plastic material that is compatible with the anolyte, catholyte, or other electrolyte that is to be disposed within the tank 190. Examples of plastic materials include, but are not limited to, polypropylene, polyethylene, polyvinyl chloride (PVC), chlorinated polyvinyl chloride (CPVC), acrylonitrile butadiene styrene (ABS), fiber reinforced epoxy, or the like or any combination thereof. In at least some embodiments, the first and second plastic layers 192, 194 are flexible. In at least some embodiments, the first and second plastic layers 192, 194 are not rigid and can be shaped by external forces. In at least some embodiments, the materials of the first and second plastic layers 192, 194 are selected to prevent or resist leakage of the anolyte, catholyte, or other electrolyte that is to be disposed within the tank 190.

In at least some embodiments, electrolyte leak detectors are disposed between two or more of the first and second plastic layers 192, 194 to detect leakage or breakage of one or more of the first and second plastic layers 192, 194. Non-limiting examples of electrolyte leak detectors include conductivity detectors, fluid detectors, electrolyte detectors, or the like or any combination thereof.

The thermal insulation layer(s) 196 can be made of any suitable material including, but not limited to, concrete, polyurethane thermal insulation material, inorganic thermal insulation material, or the like or any combination thereof In at least some embodiments, the thickness of the thermal insulation material is in a range from 1 mm to 100 mm, a range from 5 mm to 50 mm, or a range from 5 mm to 20 mm. In at least some embodiments, the thermal insulation layer(s) is/are not present within the bottom of the tank 190. In at least some embodiments, the thermal insulation layer(s) is/are not present within the top of the tank 190.

The mechanical support layer 198 can be made of any suitable material that provides mechanical support or shape boundaries to the first and second plastic layers 192, 194. Examples of suitable materials include, but are not limited, to metal, concrete (with or without rebar), wood, brick, clay blocks, plastic, or the like or any combination thereof. In at least some embodiments, the mechanical support layer comprises metal sheets. In at least some embodiments, at least a portion of the mechanical support layer has a bellows shape and, optionally, includes at least one reinforced band.

In at least some embodiments, all, or part, of the thermal insulation layer 196 or the mechanical support layer 198 (or both) are made in pieces that can be assembled together to form the layer. In at least some embodiments, the tank 190 can be assembled from parts on a site of the redox flow battery system 100.

In at least some embodiments, the tank 190 also includes at least one electrolyte inlet 191 and at least one electrolyte outlet 193. In at least some embodiments, the electrolyte inlet(s) 191 and the electrolyte outlet(s) 193 are located on a top of the tank.

In at least some embodiments, the presence of ammonia or urea in the electrolytes (for example, as ligands of the chromium complex) can facilitate rebalancing of the system and restoration of the storage capacity. In at least some embodiments, the following electrolytic reactions occur at the electrodes:

7H₂O+2CR³⁺−6e⁻→CR₂O₇²⁻+14H⁺ E₀+1.33 V

Fe³⁺+e⁻→Fe²⁺ E₀=0.77 V

The chromate ions can react with urea or ammonia to regenerate Cr³⁺ to rebalance the system:

Cr₂O₇²⁻+8H⁺+CO(NH₂)₃→2Cr³⁺+CO₂+N₂+6H₂O

Cr₂O₇²⁻+8H⁺+2NH₃→2Cr³⁺+N₂+7H₂O

In at least some embodiments, the resulting nitrogen or carbon dioxide can be released to prevent pressurization of the redox flow battery system.

Alternatively or additionally, in at least some embodiments, to rebalance the redox flow battery system the redox flow battery system includes a balance arrangement, in conjunction with either the anolyte or catholyte, to rebalance the system and restore storage capacity. In at least some embodiments, the balance arrangement utilizes a vanadium source (to produce oxovanadium (VO²⁺) and dioxovanadium (VO₂⁺) ionic species) and a reductant, such as an oxidizable hydrocarbon compound, to rebalance the system and restore storage capacity. The following embodiments illustrate the addition of a balance arrangement to a Fe—Cr redox flow battery system. It will be understood that such balance arrangements can be used with other redox flow battery systems, or other chemical and/or electrochemical systems.

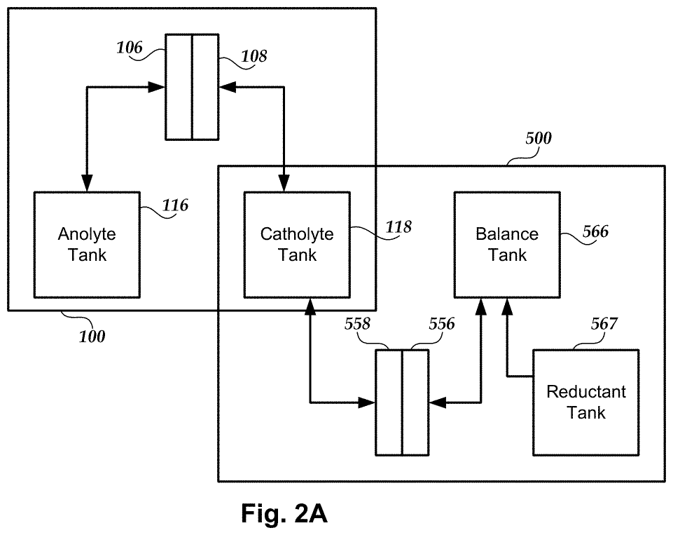

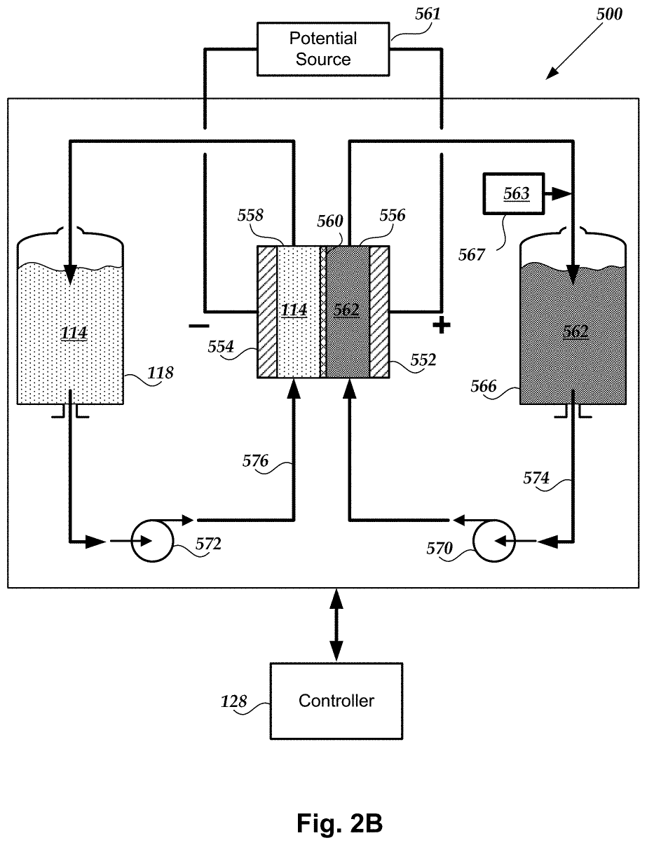

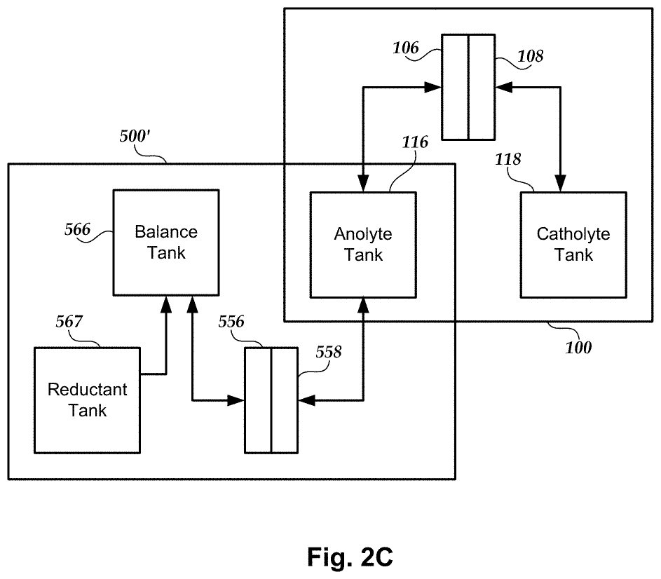

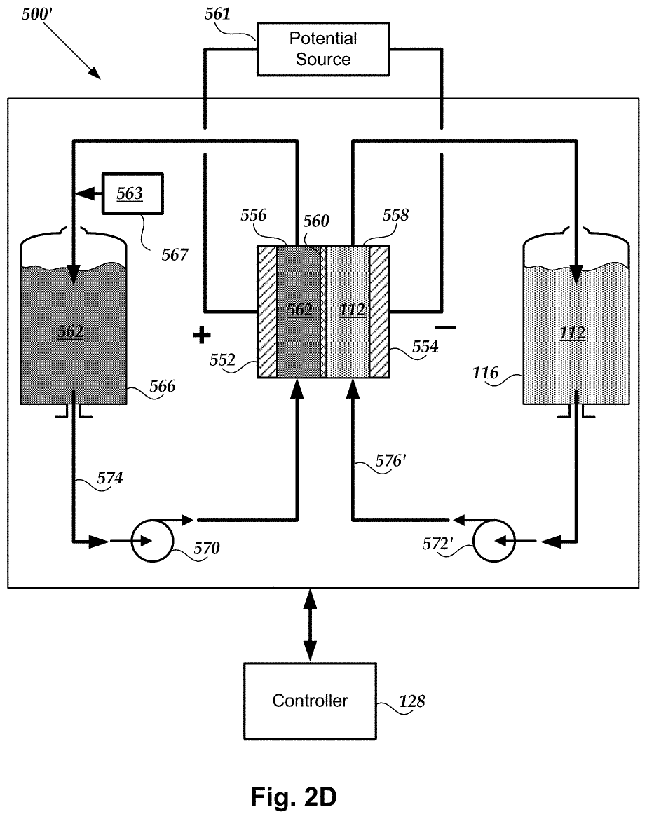

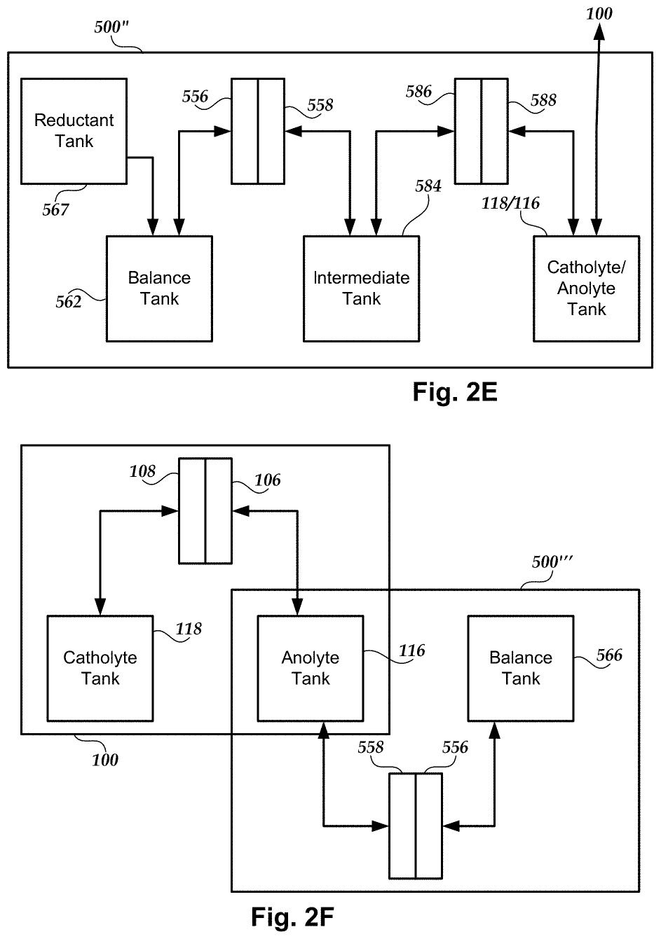

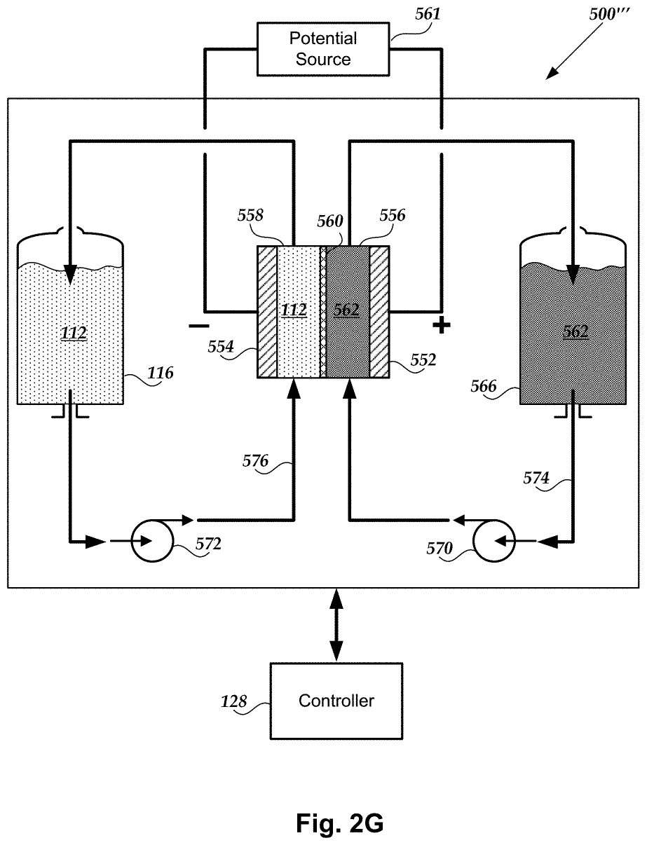

FIG. 2A illustrates one embodiment of portions of the redox flow battery system 100 and a balance arrangement 500. FIG. 2B illustrates one embodiment of the balance arrangement 500. In this embodiment, the catholyte 114 is used in conjunction with a balancing electrolyte 562 (for example, an electrolyte containing VO₂₊/VO₂⁺) and a reductant 563 to rebalance the redox flow battery system 100. The balance arrangement 500 includes the catholyte tank 118; balance electrodes 552, 554; balance half-cells 556, 558; balance separator 560; catholyte balance pump 572; catholyte balance distribution system 576; balance tank 566; optional reductant tank 567; balance electrolyte pump 570; balance electrolyte distribution arrangement 574; and potential source 561. In at least some embodiments, the reductant can be urea or ammonia which may be present as ligands of a chromium or iron complex or can be otherwise provided as a reductant.

The following reaction equations illustrate one example of the rebalancing of the system using the iron-based catholyte 114, a balancing electrolyte 562 containing oxovanadium ions, and a reductant 563 containing urea or ammonia.

VO²⁺+H₂O+Fe³⁺→VO₂⁺+Fe²⁺+2H⁺

6VO₂⁺+6H⁺+CO(NH₂)₂→6VO²⁺+CO₂+N₂+5H₂O

6VO₂⁺+6H⁺+2NH₃→6VO²⁺+N₂+6H₂O

In at least some embodiments, the resulting nitrogen or carbon dioxide can be released to prevent pressurization of the redox flow battery system.

The following reaction equations illustrate another example of the rebalancing of the system using the iron-based catholyte 114, a balancing electrolyte 562 containing oxovanadium ions, and a reductant 563 containing fructose, along with the application of an external potential from the potential source 561 of at least 0.23 V:

VO²⁺+H₂O+FE³⁺→VO₂⁺+Fe²⁺+2H⁺

24VO₂⁺+23H⁺+C₆H₁₂O₆→24VO²⁺+6CO₂+18H₂O

Via the reactions illustrated in the two examples above, the AOS of the redox flow battery system 100 can be reduced and the H+ions lost in hydrogen generation restored. In at least some embodiments, this rebalancing (or restoring of the AOS or storage capacity recovery) does not utilize any metallic catalyst as such catalysts often increase hydrogen generation. In at least some embodiments, VO²⁺ of the balance electrolyte 562 can be considered a homogeneous catalyst as the VO²⁺ ions are regenerated using the reductant 563. In at least some embodiments, the reduction of VO₂⁺ ions happens in balance half cell 566.

In at least some embodiments, the oxidation of the reductant 563 can be performed in the balance tank 566 instead of the half-cell 556 and may not require the application of an external potential, as long as VO₂⁺ ions are available. Suitable reducing agents include sugars (for example, fructose, glucose, sucrose, or the like or any combination thereof), carboxylic acids (for example, formic acid, acetic acid, propionic acid, oxalic acid, or the like or any combination thereof), aldehydes (for example, formaldehyde, acetaldehyde, or the like or any combination thereof), alcohols (for example, methanol, ethanol, propanol, or the like or any combination thereof), ammonia, urea, thiourea, ammonium ions, other hydrocarbons, or hydrogen gas. In at least some embodiments, the reductant is soluble or at least partially soluble in water.

In at least some embodiments, the reductant 563 is added either periodically, intermittently, or continuously to the balance electrolyte 562 from the reductant tank 567. In at least some embodiments, this rebalancing process (for recovering the storage capacity or restoring the AOC) occurs continuously, intermittently, or periodically. For example, the catholyte balance pump 572 and balance electrolyte pump 570 can operate continuously, intermittently, or periodically. In at least some embodiments, the catholyte pump 122 can also be used as the catholyte balance pump 572. Moreover, the catholyte balance distribution arrangement 576 may include a valve to couple to, or disconnect from, the catholyte tank 118.

FIGS. 2C and 2D illustrate another embodiment of redox flow battery system 100 with a balance arrangement 500′ which operates with the anolyte 112 (and corresponding anolyte pump 572′ and anolyte balance distribution arrangement 576′) instead of the catholyte. In at least some embodiments, the anolyte pump 120 can also be used as the anolyte balance pump 572′.

The following reaction equations illustrate one example of the rebalancing of the system using the chromium-based anolyte 112, a balancing electrolyte 562 containing oxovanadium ions, and a reductant 563 containing fructose, along with the application of an external potential from the potential source 561 of at least 1.40 V:

VO²⁺+H₂O+Cr³⁺→VO₂ ⁺+Cr²⁺+2H⁺

24VO₂ ⁺+24H⁺+C₆H₁₂O₆→24VO²⁺+6CO₂+18H₂O

Other reductants, including those listed above, can be used instead of fructose.

FIG. 2E illustrates another embodiment of a balance arrangement 500″ which can be adapted to operate with either the catholyte or anolyte and the corresponding catholyte/anolyte tank 118/116 that is coupled to the remainder of the redox flow battery system 100. This embodiment incorporates an intermediate tank 584 and two intermediate half-cells 586, 588 between the catholyte/anolyte tank 118/116 and the balance tank 566 and corresponding half-cells 556/558. (As with the balance tank, there can be an intermediate pump and intermediate distribution arrangement, as well as an intermediate separator between the two half-cells 586, 588 and a source potential to apply a potential between the electrodes of the two half-cells 586, 588.) In one embodiment, the intermediate electrolyte in the intermediate tank 584 contains V²⁺/V³⁺ ions.

The following reaction equations illustrate one example of the rebalancing of the system using balance arrangement 500″ and the catholyte 114 of redox flow battery system 100 (FIG. 1).

VO²⁺+H₂O−e⁻→VO₂⁺+2H⁺ (half-cell 556)

V³⁺+e⁻→V²⁺ (half-cell 558)

V²⁺+e⁻→V³⁺ (half-cell 586)

Fe³⁺+e⁻→Fe²⁺ (half-cell 588)

24VO₂⁺+24H⁺+C₆H₁₂O₆→24VO²⁺+6CO₂+18H₂O (balance tank 562 or half cell 556 or both)

Other reductants, including those listed above, can be used instead of fructose.

Another embodiment uses the anolyte (Cr²⁺/Cr³⁺) instead of the catholyte in conjunction with the intermediate electrolyte and balance electrolyte. Yet another embodiment uses the anolyte and replaces the V²⁺/V³⁺ intermediate electrolyte with a Fe²⁺/Fe³⁺ intermediate electrolyte.

FIGS. 2F and 2G illustrate another embodiment of a balance arrangement 500′″. In the balance arrangement 500′″, the balancing electrolyte 562 is a solution that contains both Fe²⁺ and H⁺. The balancing electrolyte 562 flows to the first balance half-cell 556 and the anolyte 112 flows to the second balance half cell 558. In at least some embodiments, the following electrolytic reactions occur at the electrodes:

Fe²⁺−e=Fe³⁺ (on the positive electrode 552 of the half-cell 556)

Cr³⁺+e=Cr²⁺ (on the negative electrode 554 of the half-cell 558)

During this process, H⁺ moves from the balance electrolyte 562 of the rebalance system 500′″ to the anolyte 114. In at least some embodiments, operation of the rebalance system 500′″ is independent of operation of the redox flow battery system 100. In at least some embodiments, the rebalance system 500′″ operates intermittently or continuously. In at least some embodiments, the rebalance system 500′″ can be controlled by the same controller 128 as the redox flow battery system 100. In other embodiments, a different controller can be used for the rebalance system 500′″. In at least some embodiments, the balance electrolyte is periodically replaced. In at least some embodiments, the rebalance system 500′″ can be modified to include an intermediate electrolyte, as described above.

It will be recognized that the balance arrangement described herein can be utilized with other redox flow battery systems and, in particular, those that are capable of generating hydrogen gas. Examples of such redox flow battery system include, but are not limited to, Zn—Br or Zn—Cl redox flow battery systems, vanadium-based (for example, all vanadium, V—Br, V—Cl, or V-polyhalide) redox flow battery systems; Fe—V or other iron-based redox flow battery systems (for example, an all iron redox flow battery system); or organic redox flow battery systems.

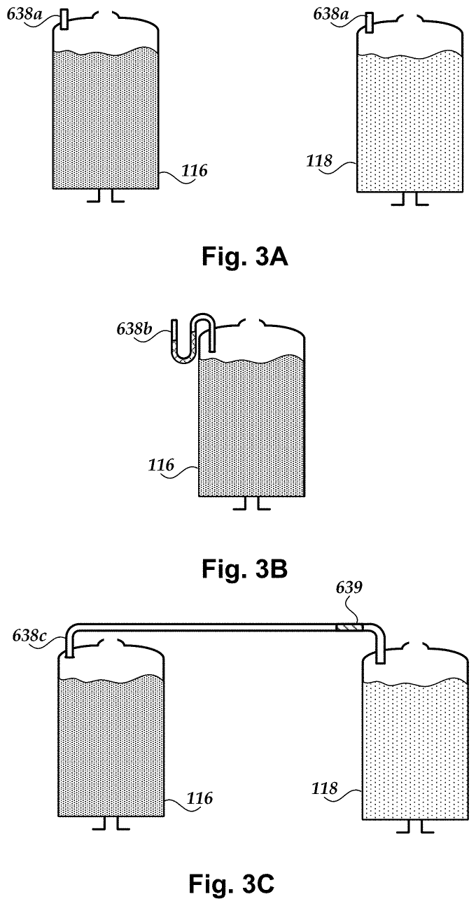

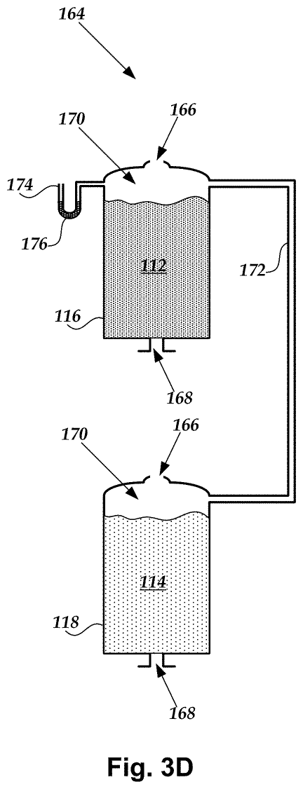

In some embodiments, during Fe²⁺ overcharging conditions, chlorine gas (Cl₂) can be generated on the catholyte side of the redox flow battery system 100. The chlorine may be confined in the catholyte headspace of, for example, the catholyte tank 118 or half-cell 108 or the like or any combination thereof. Continued generation of chlorine gas increases the pressure in the confined catholyte headspace. In at least some embodiments, this may result in the chlorine gas migrating to the anolyte headspace via a connection 638c (FIG. 3C) which optionally includes one or more valves or switches 639 to control flow. In at least some embodiments, at least a portion of the chlorine gas may be absorbed by the anolyte solution. In at least some embodiments, the following reactions can occur between chlorine and the anolyte solution to chemically discharge the over-charged system:

2Cr²⁺+Cl₂→2Cr³⁺+2Cl⁻

2Fe²⁺+Cl₂→2Fe³⁺+2Cl⁻

In at least some embodiments, the redox flow battery system 100 may include a pressure release system to manage pressure in the catholyte or anolyte headspace. For example, a pressure relief valve 638a (FIG. 3A) or a liquid-containing U-tube arrangement 638b (FIG. 3B) may be coupled to the catholyte headspace to manage the pressure. Similarly, a pressure relief valve or a liquid-containing U-tube arrangement may be coupled to the anolyte headspace. In at least some embodiments, gas in the anolyte or catholyte headspace may exchange with an environmental atmosphere via a bi-directional gas pressure control system such as the U-tube arrangement. In at least some embodiments, a U-tube arrangement may also be used as a gas leak monitor. In at least some embodiments, the liquid in a U-tube arrangement may contain an acid level indicator that can be used to estimate the amount of acid-containing gas released into the environment by the redox flow battery system.

In at least some instances, the acidic solutions and chemical vapor from leaks of the electrolytes and chemical products of the redox reactions can damage electronic devices (for example, the controller 128, switches, valves, pumps, sensors, or the like) in the redox flow battery system 100. In addition, the leaks may result in environmental damage or contamination.

In at least some embodiments, a redox flow battery system 100 (see, for example, FIG. 1) can include a leak sensor arrangement. The leak sensor arrangement 164 includes at least one anolyte tank 116 and at least one catholyte tank 118, as illustrated in FIG. 3D. Each of the anolyte and catholyte tanks 116, 118 includes at least one inlet 166 and at least one outlet 168 and has a portion that contains gas rather than liquid (e.g., gas chamber 170.) In at least some embodiments, the gas chambers 170 of the anolyte and catholyte tanks 116, 118 are connected by, for example, a piping arrangement 172. In other embodiments, the gas chambers 170 of the anolyte and catholyte tanks 116, 118 are not connected.

At least one gas chamber 170 is also connected to a bent tube 174 (for example, a U-shaped tube) containing a liquid 176. The bent tube 174 serves as a two-way pressure control valve to separate the gas chambers 170 of the anolyte and catholyte tanks 116, 118 from the environment.

The bent tube 174 can also serve as a system gas-leak sensor. In at least some embodiments, the bent tube 174 may contain a liquid level indicator that can be used to estimate or monitor gas generated by the redox flow battery system. An estimate of gas generation may be used to evaluate the performance or a change in performance of the redox flow battery system. In at least some embodiments, the liquid level indicator can include a video camera for monitoring the liquid level. In at least some embodiments, the redox flow battery system can include a computer and software for recognizing the liquid level in the video or picture stream from the video camera.

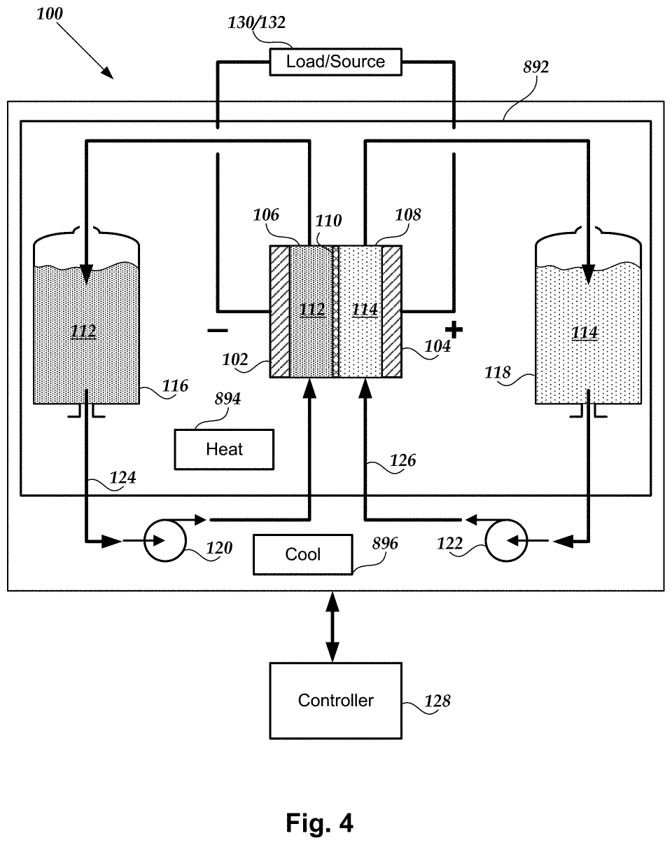

In some embodiments, the anolyte and catholyte containing components, such as the anolyte or catholyte tanks 116, 118, half-cells 106, 108, at least some portions of the anolyte or catholyte distribution systems 124, 126, electrodes 102, 104, or the like, of the redox flow battery system 100 are maintained at a temperature of at least 50, 60, 70, 20 or 80 degrees Celsius or more during charge or discharge periods in a temperature zone 892, as illustrated in FIG. 4. The temperature of these components may be maintained using one or more heating devices 894. In addition, one or more of electronic components of the redox flow battery system, such as one or more of the controller 128, the pumps 120, 122, one or more sensors, one or more valves, or the like, are maintained at a temperature of no more than 40, 35, 30, 25, or 20 degrees Celsius or less. The temperature of these components may be maintained using one or more cooling devices 896.

Heating the anolyte or catholyte (or both) can require substantial energy due to the thermal capacity of the large volume of the anolyte and catholyte. In at least some embodiments, it may be challenging to supply sufficient energy to the redox flow battery system using electric heating elements.

Direct mixing of a portion of the charged anolyte and catholyte results in discharge of at least a portion of the stored energy in these electrolytes. The stored energy resulting from the discharge can heat the electrolytes. Accordingly, by mixing a portion of the anolyte and the catholyte an internal self-discharge process occurs and the temperature of the anolyte and catholyte increases. In at least some embodiments, the mixing is carried out under charging or discharging conditions of the redox flow battery system. In at least some embodiments, the mixing is carried out when the redox flow battery system is at least partially charged.

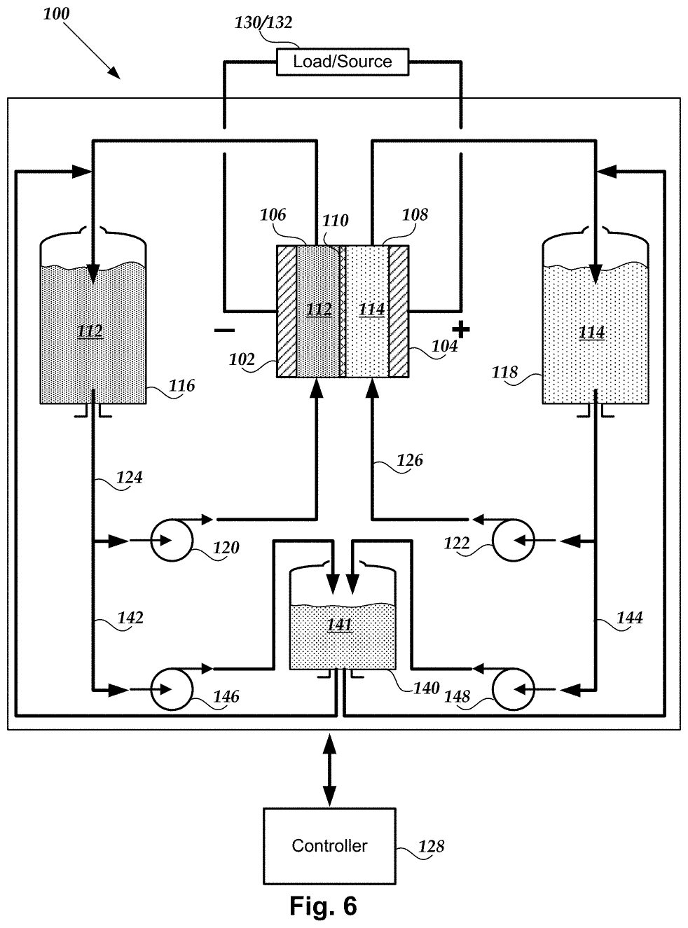

In at least some embodiments, the mixing of the anolyte 112 and catholyte 114 is performed outside of the half-cells 106, 108 using an electrolyte mixing arrangement. The mixing of the charged anolyte and catholyte can be performed by diverting a portion of the anolyte and catholyte to a mixing chamber. FIG. 6 illustrates one embodiment of a redox flow battery system 100 that includes an electrolyte mixing arrangement that has a mixing chamber 140, an anolyte mixing distribution arrangement 142, a catholyte mixing distribution system 144, an anolyte mixing pump 146, and a catholyte mixing pump 148. Although the illustrated embodiment draws the anolyte and catholyte from the anolyte and catholyte tanks 116, 118, respectively, it will be recognized that the anolyte and catholyte can be drawn from any other portion of the redox flow battery system 100.

When mixing of the anolyte and catholyte is desired, the anolyte mixing pump 146 and catholyte mixing pump 148 can be operated to draw anolyte and catholyte into the mixing chamber 140 to form a mixed electrolyte 141 that is heated by the internal discharge of the anolyte and catholyte in the mixing chamber 140. The mixed electrolyte 141 can be returned to the anolyte tank 116, catholyte tank 118 or both tanks, as illustrated in FIG. 6, (or elsewhere in the redox flow battery system).

Returning to FIG. 1, in at least some embodiments, the mixing of the anolyte 112 and catholyte 114 is carried out inside the half-cells 106, 108 using a separator 110 that is a porous membrane. The mixing can be accomplished by adjusting the pressure difference of the anolyte 112 and catholyte 114. In at least some embodiments, the redox flow battery system uses a porous separator 110. Under uneven electrolyte pressure conditions, the porous structure of the separator 110 allows mixing of the anolyte 112 and catholyte 114 in one of the half-cells 106, 108 with the lower pressure. In at least some embodiments, the pressure is determined, at least in part, by the anolyte pump 120, catholyte pump 122, or both pumps. In at least some embodiments, the pressure difference of the anolyte 112 and catholyte 114 is adjusted periodically to keep the volumes of anolyte and catholyte at desired values.

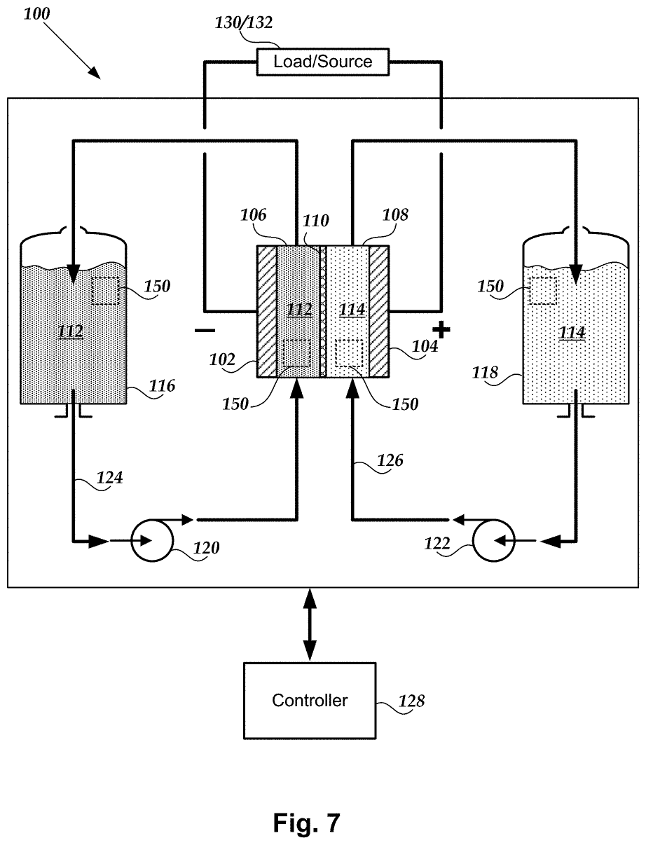

In at least some embodiments, a level sensor 150 can be used to measure the liquid level of at least one electrolyte tank (for example, the anolyte tank 116 or the catholyte tank 118 or both) as illustrated in FIG. 7. Variable flow rate pumps can be used as one or both of the anolyte and catholyte pumps 120, 122 to circulate the anolyte and catholyte through the redox flow battery system 100. The flow rates of the anolyte 112 or catholyte 114 (or both) can be adjusted according to the level difference between the anolyte and catholyte tanks 116, 118 to keep the liquid level difference in the anolyte and catholyte tanks 116, 118 at a fixed value.

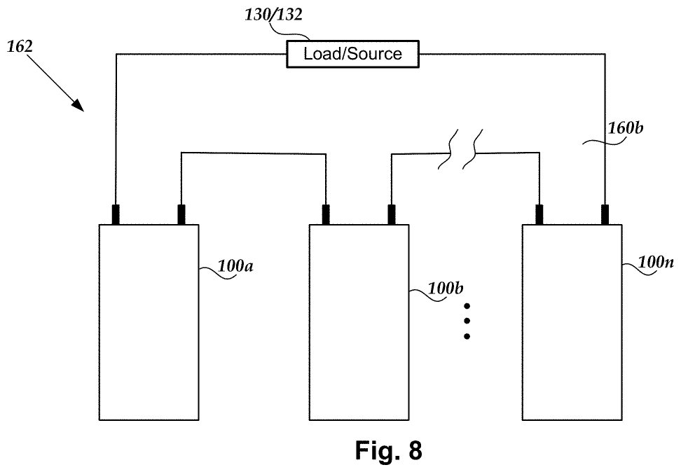

In at least some embodiment, a redox flow battery string 162 includes multiple redox flow battery systems 100a, 100b, . . . , 100n connected in series, as illustrated in FIG. 8. The overall performance of the redox flow battery string 162 is influenced by the state of charge (SOC) difference of the redox flow battery systems 100a, 100b, . . . 100n with the highest and the lowest SOC in the redox flow battery string. Any method for determining the SOC can be used including, but not limited to, the methods for determining the SOC or associated average oxidation state (AOS) disclosed herein or in

U.S. Pat. Nos. 10,777,836; 10,826,102; 11,189,854; 11,201,345; and 11,233,263 and U.S. Patent Application Publications Nos. 2022/0158207; 2022/0158211; 2022/0158212; 2022/0158213; and 2022/0158214, all of which are incorporated herein by reference in their entireties. Conventionally, matching of the redox flow battery systems 100a, 100b, . . . , 100n is often carried out by externally mixing the anolyte 112 and the catholyte 114 in the redox flow battery system with the highest SOC.

In contrast to conventional methods of matching, it is found that by adjusting the pressure difference of the anolyte and catholyte in the redox flow battery system with the highest SOC, that state of charge can be reduced in a controllable manner. Returning to FIG. 1, in at least some embodiments, the state of charge of the redox flow battery system with the highest SOC (or any other redox flow battery system) is reduced by mixing of the anolyte 112 and catholyte 114 inside the half-cells 106, 108 using a separator 110 that is a porous membrane. The mixing can be accomplished by adjusting the pressure difference of the anolyte 112 and catholyte 114. In at least some embodiments, the redox flow battery system uses a porous separator 110. Under uneven electrolyte pressure conditions, the porous structure of the separator 110 allows mixing of the anolyte 112 and catholyte 114 in one of the half-cells 106, 108 with the lower pressure. In at least some embodiments, the pressure is determined, at least in part, by the anolyte pump 120, catholyte pump 122, or both pumps.

As a result of the reduction in the state of charge of the redox flow battery system with the highest SOC, the SOC difference between the redox flow battery systems with the highest and lowest SOC is reduced. In at least some embodiments, by adjusting the pressure differences of one or more of the redox flow battery systems, the state of charge of all the redox flow battery systems 100a, 100b, . . . , 100n in a redox flow battery string 162 can be kept at, or near (for example, within 0.5, 1, 2, 5, or 10 percent or any other selected percentage), the same SOC value. In at least some embodiments, the pressure difference between the redox flow battery systems 100a, 100b, . . . , 100n can be controlled by the level of the anolyte 112 and catholyte 114 in the anolyte and catholyte tanks 116, 118. The level of the anolyte 112 and catholyte 114 can be monitored using a level sensor 150 or any other suitable level sensor or level sensor arrangement.

In addition, in at least some embodiments, the pressure difference of the anolyte 112 and catholyte 114 is altered periodically in one or more of the redox flow battery systems 100a, 100b, . . . , 100n to keep the anolyte and catholyte volumes at desired values.

In at least some embodiments, after electrolyte (e.g., anolyte and catholyte) circulation stops, the energy of the charged electrolytes inside a redox flow battery system can cause some areas to overheat and damage the redox flow battery system. In at least some embodiments, energy is released to prevent the redox flow battery system from overheating. However, in at least some instances, this energy cannot be discharged as electricity to an outside load.

In at least some embodiments, a redox flow battery system can be operated or designed to consume this extra energy. Returning to FIG. 1, in at least some redox flow battery systems 100, such as a Fe—Cr redox flow battery system, a porous separator 110 is used. By stopping or halting either the anolyte pump 120 or the catholyte pump 122 before the other one of these pumps 120, 122, the pressure difference between the anolyte 112 and the catholyte 114 will cause the anolyte or catholyte to pass through the separator 110 to reduce the pressure difference. This results in mixing of the anolyte 112 and the catholyte in one of the half-cells 106, 108 which reduces the amount of stored energy in the redox flow battery system 100 by internal discharge. Accordingly, the stored energy that would damage the redox flow battery system after electrolyte circulation stops or halts can be safely released. In at least some embodiments, the anolyte pump 120 or catholyte pump 122 stops or halts 10, 5, 3, 2, 1 minutes before the other one of these pumps. In at least some embodiments, the one of the pumps 120, 122 that continues operating will operate at full speed or at a reduced speed (for example, at no more than 75%, 50%, or 30% of full speed.) In at least some embodiments, the one of the pumps 120, 122 that continues operating reduces speed over the period of time that it is solely operated. For example, the reduction can be from a starting speed that is full speed or at least 75% or 50% of full speed to an ending speed of 0%, 30%, 50%, or 75% of full speed.

Other methods can be used to convert chromite ore into the chromium-containing compound used in the anolyte or catholyte described above. Chromite ore has the chemical formula FeCr₂O₄ and a theoretical composition of 32.0% FeO and 68.0% Cr₂O₃. In at least some embodiments, sodium chromate is generated from chromite ore by soda ash roasting (e.g., heating chromite ore and sodium carbonate) at elevated temperature (for example, at least 800, 850, or 900° C.) in an oxidizing environment (e.g., an atmosphere containing element oxygen or in the presence of oxygen.) For example:

FeCr₂O₄+2Na₂CO₃+7/4O₂→2Na₂CrO₄+½Fe₂O₃+2CO₂

Hydrochloric acid and a hydrocarbon reductant are added to reduce the chromium atoms from the +6 oxidation state to the +3 oxidation state and produce CrCl₃ and FeCl₃. Examples of hydrocarbon reductants include, but are not limited to, ethanol, methanol, propanol, isopropanol, other alcohols, formic acid acetic acid, fructose, glucose, other carboxylic acids, or the like or any combination thereof. As any example, ethanol can be used as the hydrocarbon reductant according to the following reactions:

4Na₂CrO₄+CH₃CH₂OH+20HCl→8NaCl+4CrCl₃+13H₂O+2CO₂

Fe₂O₃+6HCl→2FeCl₃+3H₂O

Water-insoluble impurities, such as SiO₂, can be filtered out of the solution.

NaCl can be separated from the CrCl₃—FeCl₃ mixture via water evaporation followed by low-temperature crystallization based on solubility differences at different temperatures. Compared to NaCl, the solubilities of CrCl₃and FeCl₃ change much more when solution temperature changes. In at least some embodiments, heat from the chromium reduction reaction above can be used for NaCl removal or for concentrating the CrCl₃—FeCl₃ mixture (or subsequent CrCl₃—FeCl₂ electrolyte solution.)

Water-soluble impurities, such as AlCl₃ and MgCl₂, can be separated out during the NaCl removal by controlling the crystallization conditions. Alternatively, these impurities, or ions such as Na⁺, Al³⁺, and Mg²⁺, can be separated out from the CrCl₃—FeCl₃ mixture using any other suitable methods, such as an ion-exchange process (e.g., a cationic ion exchange process.) In at least some embodiments, a small quantity of these impurities can be left in the electrolyte solution as these impurities are inert species for redox reactions.

Metallic iron powder can be added to the CrCl₃—FeCl₃ mixture before, during, or after the removal of NaCl. The addition of metallic iron produces the CrCl₃—FeCl₃ solution for the Fe—Cr redox flow battery system:

Fe+2FeCl₃→3FeCl₂

The metallic iron can also reduce any remaining Cr(VI)-containing species. Any remaining HCl in any of the process steps above can be neutralized by adding Fe, FeO, Fe₂O₃, Fe(OH)₂, Fe(OH)₃, Cr(OH)₃, or the like or any combination thereof.

Other chromium material can also be used. Such chromium materials can include chromium waste materials, such as platting wastes, leather tanning wastes and the like (including chromium-containing materials with Cr⁶⁺ compounds which can be first reduced by reductants such as iron power or Fe²⁺ or Cr^{3 +} compounds). These chromium materials can be dissolved using acids, such as hydrochloric acid or sulfuric acid, to generate chromium salts. The pH of the dissolved chromium can be increased to pH>3, 5, 7, or more to produce Cr(OH)₃. In at least some embodiments, the choice of acid and pH can provide other chromium compounds, such as, for example:

Cr(OH)₃+3HCl→CrCl₃+3H₂O

2Cr(OH)₃+3H₂SO₄→Cr₂(SPO₄)₃+6H₂O

Alternatively, adding FeCl₂, Fe+FeCl₃, Fe(OH)₂, or Fe+Fe(OH)₃ in combination with HCl can produce the electrolyte composition.

CrCl₃ can also be generated from Cr₂(SO₄)₃ waste material. The waste material containing Cr₂(SO₄)₃ is dissolved in water. The pH of this solution is adjusted using, for example, an alkaline hydroxide to a pH in the range of 8to 12 (for example, pH 10) to produce a gel-like Cr(OH)₃ precipitate. Optionally, at least a portion of the free water (for example, 10% to 70%) can be removed from the precipitate using any suitable water removal process, such as pressing (e.g., press filtration) or centrifuging.

The precipitate is heated to remove most of the water. For example, the precipitate can be heated at 60-100° C. for 1 to 6 hours. The heating destroys the gel-like structure of the Cr(OH)₃ precipitate. The heating can also crystalize the water-soluble alkaline sulfate salts. Alternatively or additionally, propanol or another alcohol is added to the Cr(OH)₃ precipitate to facilitate water removal and Cr(OH)₃ gel structure destruction.

Water, preferably warm to hot water (50 to 100° C.), is used leach the alkaline sulfate salts out of the Cr(OH)₃ precipitate. A filtration device may be used to remove the alkaline sulfate salts.

The resulting low impurity Cr(OH)₃ is dissolved in HCl. Water is evaporated, followed by crystallization to produce CrCl₃ (e.g., CrCl₃·6H₂ O with low impurities.

Chromium-containing wastes from the electroplating industry and from the leather tanning industry are often converted into “chromium cakes,” which are disposed in landfills or recycled into chromium oxide green. A major component of these chromium cakes is Cr(OH)₃. Also included in the chromium cakes is a large amount of water, inorganic salts, and organic debris from leather processing. Due to the gel-like structure of the chromium cake, it can be difficult to remove these impurities.

To generate CrCl₃, the chromium cake waste is heated to remove most of the water. For example, the precipitate can be heated at 60-100° C. for 1 to 6 hours. The heating may also crystallize water-soluble salt impurities. Water, preferably warm to hot water (50 to 100° C.), is then used to leach the soluble salts, preferably using a filtration device. In at least some embodiments, the hot water may be obtained from the initial heating step or a later filtering step.

The resulting low impurity Cr(OH)₃ in dissolved in a HCl solution. In at least some embodiments, an anti-foaming agent is added to prevent or reduce foaming. Examples of anti-foaming agents include, but are not limited to, alkyl polyacrylates, castor oil, fatty acids, fatty acid esters, fatty acid sulfates, fatty alcohols, fatty alcohol esters, fatty alcohol sulfates, olive oil, mono- or diglycerides, paraffin oil, paraffin wax, polypropylene glycol, silicone oil, vegetable or animal fats, sulfates of vegetable or animal fats, vegetable or animal oil, sulfates of vegetable or animal oil, vegetable or animal wax, or sulfates of vegetable or animal wax.

The HCl solution is filtered to remove insoluble materials, such as organic debris and SiO₂. Water is evaporated followed by crystallization to produce CrCl₃ (e.g., CrCl₃·6H₂O) with low impurities.

In some instances, charging conditions of a Fe—Cr redox flow battery can cause the positive electrode to become fully or partially deactivated by Fe(OH)3 precipitation or can cause the surface of the negative electrode to be covered by hydrogenation catalysts, which will initiate hydrogen generation. In at least some embodiments, an electrode surface can be re-activated by periodically deep-discharging the redox flow battery or by introducing positive electrolytes to the half cell 108 or introducing negative electrolytes to the half cell 106 (or both).

In at least some embodiments, a deep discharge operation can be performed using a power electronics system, with or without electrolyte flow. In at least some embodiments, the deep discharge operation is performed by reversing the positive and negative terminals.

In at least some embodiments, the introduction of an electrolyte to the opposite half-cell can be performed by adjusting an electrolyte pressure difference between the anolyte and catholyte, allowing introduction of the analyte into the half-cell 108 or introduction of the catholyte into the half-cell 106 through the porous separator 110. The catholyte can dissolve the Fe(OH)₃ precipitate by reducing the Fe³⁺ to Fe²⁺. The anolyte can dissolve the hydrogenation catalyst by oxidizing the metallic particles to cations.

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The following detailed description is, therefore, not to be taken in a limiting sense. The methods described herein can be performed using any type of processor and any suitable type of device that includes a processor.

It will be understood that each block of the flowchart illustrations, and combinations of blocks in the flowchart illustrations and methods disclosed herein, can be implemented by computer program instructions. These program instructions may be provided to a processor to produce a machine, such that the instructions, which execute on the processor, create means for implementing the actions specified in the flowchart block or blocks disclosed herein. The computer program instructions may be executed by a processor to cause a series of operational steps to be performed by the processor to produce a computer implemented process. The computer program instructions may also cause at least some of the operational steps to be performed in parallel. Moreover, some of the steps may also be performed across more than one processor, such as might arise in a multi-processor computer system. In addition, one or more processes may also be performed concurrently with other processes, or even in a different sequence than illustrated without departing from the scope or spirit of the invention.

The computer program instructions can be stored on any suitable computer-readable medium including, but not limited to, RAM, ROM, EEPROM, flash memory or other memory technology, CD-ROM, digital versatile disks (“DVD”) or other optical storage, magnetic cassettes, magnetic tape, magnetic disk storage or other magnetic storage devices, or any other medium (which may be local or nonlocal to the computer) which can be used to store the desired information and which can be accessed by a processor.

The above specification provides a description of the manufacture and use of the invention. Since many embodiments of the invention can be made without departing from the spirit and scope of the invention, the invention also resides in the claims hereinafter appended.

What is claimed as new and desired to be protected is:

1. A redox flow battery system, comprising:
an anolyte;
a catholyte;
a first electrode structure comprising a first electrode, a second electrode, and a base disposed between the first and second electrodes, the base comprising a thermoplastic material and conductive elements disposed in the thermoplastic material, wherein at least one of the first electrode or the second electrode is thermally bonded to the base by heating the base to soften the thermoplastic material and pressing the at least one of the first electrode or the second electrode into the thermoplastic material of the base;
a first half-cell in which the first electrode is in contact with the anolyte; and
a second half-cell in which the second electrode is in contact with the catholyte.

2. The redox flow battery system of claim 1, wherein the thermoplastic material comprises at least one of polyethylene, polypropylene, polyvinylidene fluoride, polyvinyl chloride, or chlorinated polyvinyl chloride.

3. The redox flow battery system of claim 1, wherein the conductive elements comprise graphite or carbon particulates, particles, or fibers.

4. The redox flow battery system of claim 1, wherein the first and second electrodes comprise graphite or carbon-based felt.

5. The redox flow battery system of claim 1, wherein the at least one of the first electrode or the second electrode is thermally bonded to the base by heating the base to a temperature above a glass transition temperature of the thermoplastic material.

6. The redox flow battery system of claim 1, wherein the at least one of the first electrode or the second electrode is thermally bonded to the base by heating the base to a temperature of no more than 300, 250, 200, 150, 100, or 80° C.

7. The redox flow battery system of claim 1, wherein the at least one of the first electrode or the second electrode is thermally bonded to the base by heating the base and applying a pressure of no more than 1, 0.5, 0.1, 0.05, or 0.01 MPa.

8. The redox flow battery system of claim 1, wherein the at least one of the first electrode or the second electrode is thermally bonded to the base by heating the base, applying a pressure, and maintaining the pressure as the base cools below a glass transition temperature of the thermoplastic material.

9. The redox flow battery system of claim 1, wherein the at least one of the first electrode or the second electrode is thermally bonded to the base by heating the base to a temperature above 70° C. and applying a pressure and maintaining the pressure as the base cools below a temperature in a range of 20 to 60° C.

10. The redox flow battery system of claim 1, wherein the base comprises 10 to 70 wt. % of the thermoplastic material.

11. The redox flow battery system of claim 1, wherein the base has a thickness in a range of 0.1 to 5 mm.

12. A method of making an electrode structure, the method comprising forming a slurry comprising a) particulates, particles, or fibers made of graphite or carbon, b) particles of a thermoplastic material, and c) an inert liquid;
forming the slurry into a sheet;
pressing at least one electrode against the sheet; and
extracting the inert liquid to leave a base attached to the at least one electrode, the base comprising the thermoplastic material and the particulates, particles, or fibers made of graphite or carbon disposed in the thermoplastic material.

13. The method of claim 12, wherein the at least one electrode is two electrodes and the pressing comprises pressing the two electrodes against opposite sides of the sheet.

14. The method of claim 12, wherein the slurry comprises 0.1 to 50 wt. % of the inert liquid.

15. The method of claim 12, wherein the thermoplastic material comprises at least one of polyethylene, polypropylene, polyvinylidene fluoride, polyvinyl chloride, or chlorinated polyvinyl chloride.

16. A method of making an electrode structure, the method comprising
providing a base comprising a thermoplastic material and conductive elements disposed in the thermoplastic material;
heating the base to soften the thermoplastic material; and
pressing at least one electrode into the thermoplastic material of the base.

17. The method of claim 16, wherein the at least one electrode comprises a first electrode and a second electrode, wherein the pressing comprises pressing the first and second electrodes into the thermoplastic material on opposite sides of the base.

18. The method of claim 16, wherein the heating comprises heating the base to a temperature above 70° C. and the pressing comprises applying a pressure to the at least one electrode and maintaining the pressure as the base cools below a temperature in a range of 20 to 60° C.

19. The method of claim 16, wherein the pressing comprises applying a pressure of no more than 1, 0.5, 0.1, 0.05, or 0.01 MPa to the at least one electrode.

20. The method of claim 16, wherein the heating comprises heating the base to a temperature of no more than 300, 250, 200, 150, 100, or 80° C.
